(19) United States
(12) Patent Application Publication
(10) Pub. No.: US 2016/0161645 A1
(43) Pub. Date: Jun. 9, 2016

(54) NON-VISIBLE LIGHT REFLECTIVE SHEET, OPTICAL SHEET, AND DISPLAY APPARATUS

(71) Applicant: Panasonic Intellectual Property Management Co., Ltd., Osaka (JP)

(72) Inventor: Hiroshi YAMAGUCHI, Osaka (JP)

(21) Appl. No.: 14/955,076

(22) Filed: Dec. 1, 2015

(30) Foreign Application Priority Data
Dec. 3, 2014 (JP) 2014-244621
Nov. 25, 2015 (JP) 2015-229701

(51) Int. Cl. G02B 5/08; G06F 3/0354

(52) U.S. Cl. CPC G02B 5/0816; G06F 3/03542

(57) ABSTRACT

The present disclosure provides a non-visible light reflective sheet including a base material having a corrugated surface on a reference surface, and a reflective layer formed along the corrugated surface and reflecting non-visible light. As for the non-visible light reflective sheet, when an angle of a tangent of the corrugated surface being inclined with respect to the reference surface is an inclination angle, a distribution rate of the inclination angle of 25 deg is 1.0[%/deg] or more, and a proportion of a projected area, onto the reference surface, of a region where the inclination angle is 40 deg or more to a total area of the reference surface is 20% or less. Thus, the non-visible light reflective sheet having a further excellent reflection characteristic can be provided.

### BACKGROUND

1. Technical Field

The present disclosure relates to a non-visible light reflective sheet, an optical sheet, and a display apparatus.

2. Description of the Related Art There is a known technique in which coordinates on a display apparatus are detected by an input pen or the like, and a display apparatus displays information such as letters based on the coordinate information detected by the input pen. In realizing the technique, the display apparatus includes a reflective layer that reflects non-visible light emitted from the input pen (for example, see Unexamined Japanese Patent Publication No. 2008-209598).

### SUMMARY

The present disclosure provides a non-visible light reflective sheet including:

a base material having a corrugated surface on a reference surface; and

a reflective layer formed along the corrugated surface and reflecting non-visible light, wherein,

when an angle of a tangent of the corrugated surface being inclined with respect to the reference surface is an inclination angle, a distribution rate of the inclination angle of 25 deg is 1.0[%/deg] or more, and a proportion of a projected area, onto the reference surface, of a region where the inclination angle is 40 deg or more to a total area of the reference surface is 20% or less.

According to the present disclosure, a non-visible light reflective sheet, an optical sheet, and a display apparatus having a further excellent reflection characteristic to non-visible light can be provided.

### BRIEF DESCRIPTION OF DRAWINGS

FIG. 1 is a diagram showing an overview of an information display system according to an exemplary embodiment;

FIG. 2 is a schematic diagram showing a structure of an electronic pen and a display apparatus in the information display system according to the exemplary embodiment;

FIG. 3 is an explanatory diagram showing one example of a position information pattern arranged in a display unit of the display apparatus;

FIG. 4A is an explanatory diagram showing a dot arranged as being shifted rightward from a reference for obtaining position coordinates from the position information pattern;

FIG. 4B is an explanatory diagram showing a dot arranged as being shifted upward from the reference for obtaining position coordinates from the position information pattern;

FIG. 4C is an explanatory diagram showing a dot arranged as being shifted leftward from the reference for obtaining position coordinates from the position information pattern;

FIG. 4D is an explanatory diagram showing a dot arranged as being shifted downward from the reference for obtaining position coordinates from the position information pattern;

FIG. 5 is a schematic structure diagram showing a structure of an optical sheet in which the position information pattern is arranged, in the display apparatus;

FIG. 6 is a diagram for describing a condition of reflecting reflected light toward a direction from which infrared light has been input from the electronic pen;

FIG. 7 is a diagram showing a relationship between an incident angle of light (an attitude angle of the electronic pen) and an inclination angle necessary for causing return reflection for the incident angle;

FIG. 8A is a diagram showing an existence rate of surfaces around a particular inclination angle in a corrugated surface on a knobby base material;

FIG. 8B is a diagram showing a distribution rate of surfaces around a particular inclination angle in the corrugated surface on the knobby base material;

FIG. 8C is a diagram showing the existence rate of surfaces around a particular inclination angle in the corrugated surface on the knobby base material;

FIG. 8D is a diagram showing the distribution rate of surfaces around a particular inclination angle in the corrugated surface on the knobby base material;

FIG. 9A is a surface photograph in Example 1;

FIG. 9B is a surface photograph in Example 2;

FIG. 9C is a surface photograph in Example 3;

FIG. 9D is a surface photograph in Comparative Example 1;

FIG. 9E is a surface photograph in Comparative Example 2;

FIG. 10 is a diagram showing the distribution rate to the inclination angle in Examples and Comparative Examples;

FIG. 11 is a diagram showing a structure of a test sheet and a diffuse reflection measuring apparatus;

FIG. 12 is a diagram showing diffuse reflectance at various measurement angles with wavelength of 950 nm in Examples and Comparative Examples; and

FIG. 13 is a diagram showing reflectivity to wavelengths in Examples and Comparative Examples.

### DETAILED DESCRIPTION

In the following, with reference to the drawings as appropriate, a description will be given of an embodiment. However, an unnecessarily detailed description may be omitted. For example, a detailed description of an already well-known matter or repetitive descriptions for substantially identical structures may be omitted. This is to avoid unnecessary redundancy in the following description, and to facilitate understanding of a person skilled in the art.

Note that, the inventor provides the accompanying drawings and the following description for a person skilled in the art to fully understand the present disclosure, and the drawings and the description are not intended to limit the subject stated in the scope of claims

In the following, as one example of display apparatus 200 of an information display system according to one embodiment of the present disclosure, an apparatus adopting a liquid crystal display apparatus is exemplarily shown and described. However, the present disclosure is not limited to the liquid crystal display apparatus, and other display apparatus such as an EL (Electro Luminescence) display apparatus may be adopted.

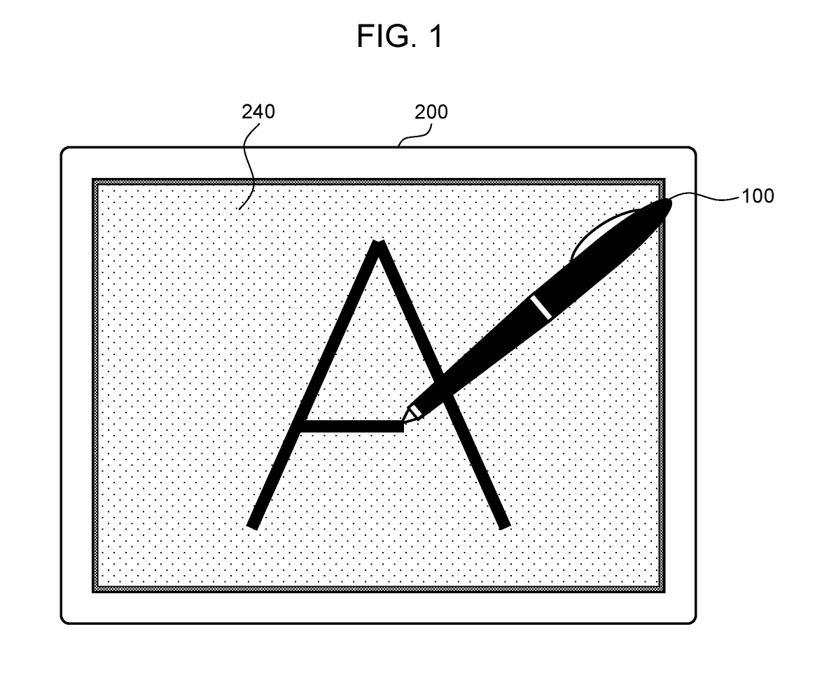

FIG. 1 is a diagram showing an overview of the information display system according to one embodiment. As shown in FIG. 1, the information display system is structured by electronic pen 100 and display apparatus 200. A user uses electronic pen 100 by bringing it close to display unit 240 of display apparatus 200. At this time, electronic pen 100 optically reads a position information pattern formed on display unit 240 of display apparatus 200. Electronic pen 100 transmits the read position information pattern to display apparatus 200, thereby notify display apparatus 200 of a position where electronic pen 100 is made close to display apparatus 200. Based on the position information pattern notified by electronic pen 100, display apparatus 200 displays, on display unit 240, letters, figures and the like handwritten by the user. Thus, the user can write letters and the like on display unit 240 of display apparatus 200 in a manner of handwriting letters and the like on paper with an ink pen.

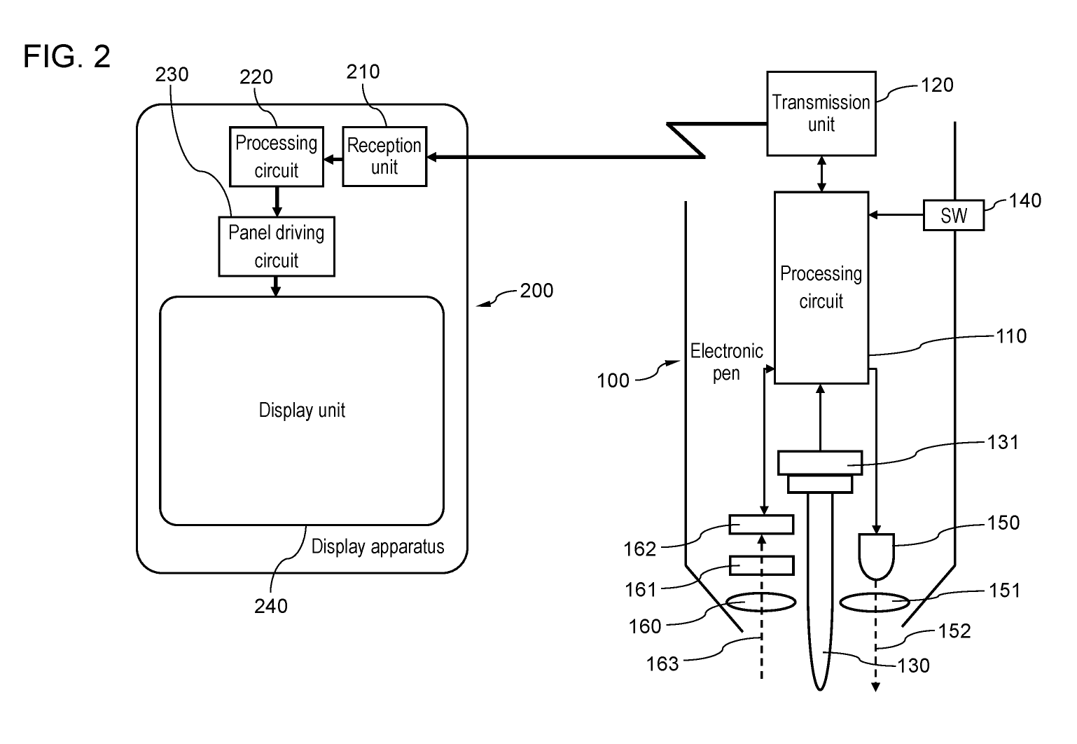

FIG. 2 is a schematic diagram showing structures of electronic pen 100 and display apparatus 200 in the information display system according to the one embodiment.

As shown in FIG. 2, electronic pen 100 includes processing circuit 110, transmission unit 120, pen nib 130, pressure sensor 131, switch 140, LED (Light Emitting Diode) 150, condensing lenses 151 and 160, IR (Infra Red) filter 161, and image reading unit 162. On the other hand, display apparatus 200 includes reception unit 210, processing circuit 220, panel driving circuit 230, and display unit 240.

Pen nib 130 is disposed at the tip of electronic pen 100. When pen nib 130 is brought into contact with display unit 240 of display apparatus 200, pressure sensor 131 disposed in electronic pen 100 senses a tool pressure of pen nib 130. Then, pressure sensor 131 transmits a signal indicative of sensing the tool pressure to processing circuit 110. In response to the signal, processing circuit 110 causes LED 150 to start emitting illumination light 152 having a spectral characteristic in the infrared region, and causes image reading unit 162 to start outputting read data. Note that, the present disclosure is not limited to the structure in which the operations of LED 150 and image reading unit 162 are started when pressure sensor 131 senses the tool pressure. For example, the operations of LED 150 and image reading unit 162 may be started in response to the user pressing switch 140 for inputting an instruction to read, even when electronic pen 100 is spaced apart from display unit 240.

Illumination light 152 emitted from LED 150 of electronic pen 100 is condensed by condensing lens 151, and thereafter illuminates a portion on display unit 240 of display apparatus 200, where electronic pen 100 is made close to display unit 240. Then, illumination light 152 is reflected by display unit 240 of display apparatus 200 and becomes reflected light 163. Reflected light 163 is condensed by condensing lens 160 and passes through IR filter 161 which blocks visible light and transmits infrared light. Thereafter, reflected light 163 enters image reading unit 162. Image reading unit 162 is structured by an imaging element (e.g., a CCD) that receives infrared light and generates an image.

Reflected light 163 reflected by display unit 240 of display apparatus 200 includes information relating to a position information pattern corresponding to the position to which electronic pen 100 is made close. Image reading unit 162 images reflected light 163 containing the information relating to the position information pattern, to generate an image. The image generated by image reading unit 162 is sent to processing circuit 110. Processing circuit 110 recognizes, from the acquired image, a dot-formed image included in the position information pattern. Then, processing circuit 110 processes data of the recognized image, and detects coordinates of the position specified by the electronic pen 100. Processing circuit 110 sends the detected coordinate data to transmission unit 120. Transmission unit 120 transmits the coordinate data to reception unit 210 of display apparatus 200 by wireless communication.

Display apparatus 200 controls panel driving circuit 230 by processing circuit 220 processing the coordinate data received at reception unit 210. As a result, based on the coordinate position recognized by electronic pen 100, letters or figures are displayed on display unit 240.

In the above-described series of the operations, coordinate detection is performed following electronic pen 100 that shifts. Accordingly, image reading unit 162 intermittently opens a shutter. The shorter the opening time of the shutter, the smaller blur of an image during the exposure time, and hence a swift movement of electronic pen 100 can be supported. The exposure time is automatically adjusted to the minimum time with which necessary brightness of an image is obtained. The brightness of an image per unit exposure time is determined by an illumination capacity of LED 150 and reflection performance of optical sheet 300 which will be detailed later. That is, as the illumination capacity of LED 150 and the reflection performance of optical sheet 300 are greater, the exposure time can be shortened, and the swift movement of electronic pen 100 can be supported. Further, LED 150 may emit light only during the exposure time. In the case where LED 150 of a certain illumination capacity is used, power consumption can be reduced as the reflection performance of optical sheet 300 is greater.

As shown in FIG. 2, in electronic pen 100, since LED 150 and image reading unit 162 are positioned close to each other, an incident angle of illumination light 152 to optical sheet 300 and a reflection angle of effective reflected light 163 contributing to reading an image must be substantially equal to each other. Accordingly, average reflectivity does not meet a requirement of the reflection performance of optical sheet 300. Optical sheet 300 is required to have the performance of reflecting light substantially toward a direction from which the light has been input. Details of a structure of optical sheet 300 will be described later.

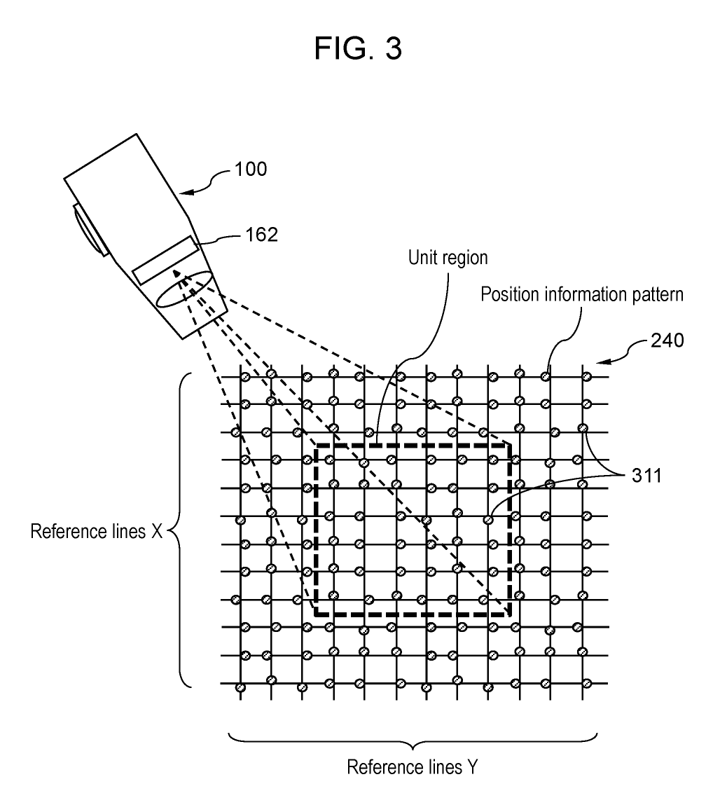

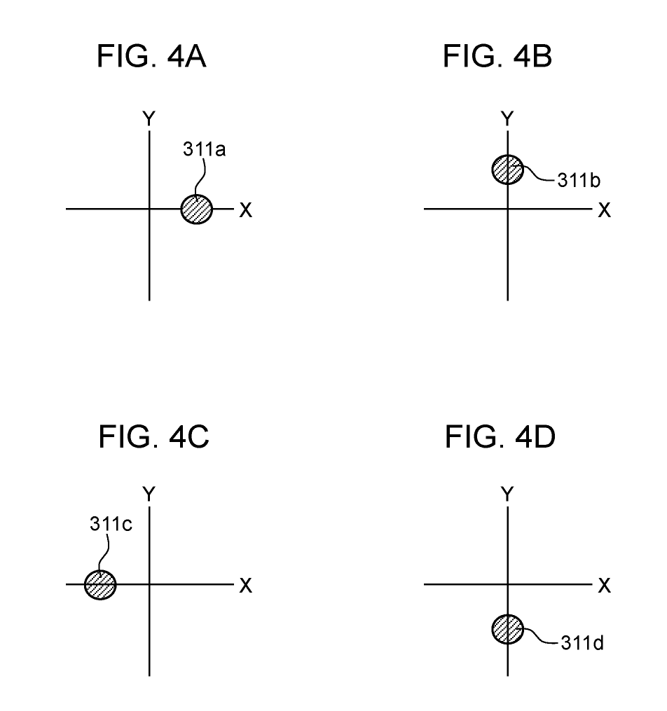

Subsequently, with reference to FIGS. 3 and 4A to 4D, a description will be given of the position information pattern optically read by electronic pen 100. FIG. 3 is an explanatory diagram showing one example of the position information pattern arranged on display unit 240 of display apparatus 200. FIGS. 4A to 4D are explanatory diagrams collectively showing one example of a method of obtaining position coordinates from the position information pattern.

As shown in FIG. 3, in a display region of display unit 240 of display apparatus 200, the position information pattern in which a plurality of dots 311 are formed in a particular arrangement pattern is arranged. Then, on the display region of display unit 240, a unit region configured by m dots×n dots is defined. In the present exemplary embodiment, for example a unit region is a pixel region of 6 dots×6 dots. Here, electronic pen 100 recognizes, by reading the arrangement of the dot shapes formed as the position information pattern in the unit region to which electronic pen 100 is made close on display unit 240, the position coordinates pointed by electronic pen 100 closely positioned.

As shown in FIGS. 3 and 4A to 4D, dots 311 of the position information pattern are arranged with reference to intersection points formed by grid-like reference lines X and reference lines Y. Specifically, dot 311a, dot 311b, dot 311c, and dot 311d are arranged as being respectively shifted to the right side, the upper side, the left side, or the lower side relative to one of the referential intersection points, whereby an array pattern configured by a plurality of dots 311 is formed. Then, to the arrangement of dot 311a, dot 311b, dot 311c, and dot 311d, for example symbols “1”, “2”, “3”, and “4” representing the position coordinates are respectively assigned. When the unit region is configured by 6 dots×6 dots, 36 pieces of dots 311 are arranged in the unit region at any one of the four shift positions shown in FIGS. 4A to 4D. Corresponding to a number represented by combination of the shift positions of 36-piece dots 311, coordinate position of the unit region is defined. Thus, in accordance with a specific position in display unit 240, a position information pattern representing the coordinate position of the specific position can be formed. Then, by reading dots 311 formed in the position information pattern in the unit region, electronic pen 100 can determine the position coordinates of the unit region.

Note that, dots 311 forming the position information pattern is made of a material that absorbs infrared light (non-visible light) while transmitting visible light, or a material that reflects infrared light (non-visible light) while transmitting visible light. Thus, it becomes possible to reduce influence on visibility of a displayed image formed by light in the visible light region displayed on display unit 240 of display apparatus 200.

Further, dots 311 may be made of a material having a light scattering characteristic or a diffraction grating characteristic by being irradiated with infrared light, so as to change a direction of incident infrared light. In this case, by virtue of dots 311 having the light scattering characteristic or the diffraction characteristic, the incident light is reflected (scattered, diffused, diffracted, phase-changed, bent) by dots 311, and thereafter is output again outside display apparatus 200. By the reflected light, electronic pen 100 can detect the position information pattern formed by dots 311.

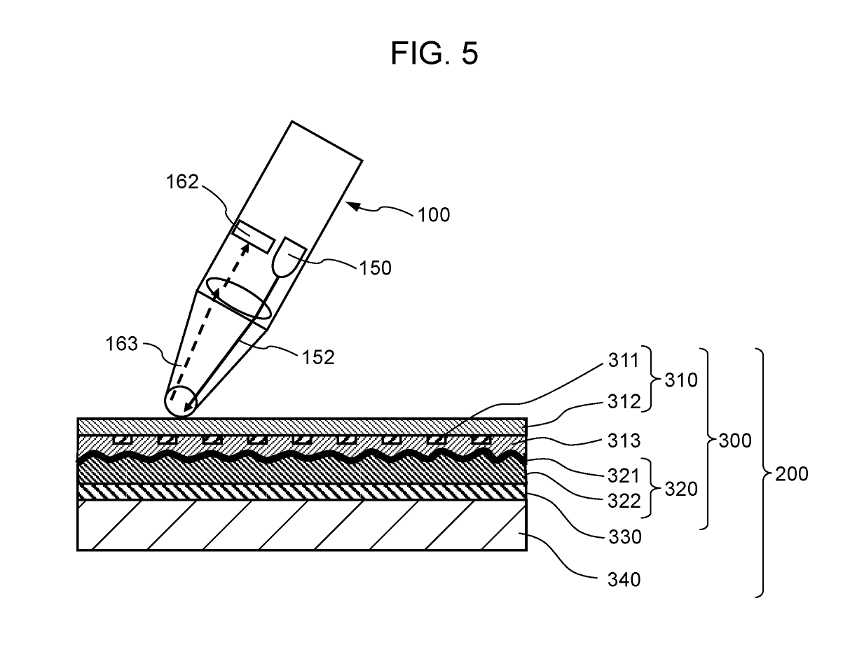

Next, with reference to FIG. 5, a description will be given of one example of a structure of display apparatus 200 relating to reflection of infrared light. FIG. 5 is a schematic structure diagram showing a structure of optical sheet 300 in which the position information pattern is arranged in display apparatus 200. Note that, in FIG. 5, as to electronic pen 100, only the representative optical elements are shown in a simplified manner, out of the constituent elements shown in FIG. 2.

As shown in FIG. 5, display apparatus 200 is structured by a stack-layer structure of optical sheet 300, transparent adhesion layer 330, and liquid crystal panel 340.

Optical sheet 300 is structured by a stack-layer structure of dot pattern sheet 310, transparent adhesion layer 313, and infrared reflective sheet 320.

Dot pattern sheet 310 is made of PET film 312 as a base material which is provided with the position information pattern formed by a plurality of dots 311.

PET film 312 protects a surface of display unit 240 of display apparatus 200. PET film 312 functions as a base material for stacking layers such as dots 311 and others. On a back surface of PET film 312 (a lower surface in FIG. 5), the plurality of dots 311 are stacked. Dots 311 are protruded from the back surface of PET film 312 by thickness of dots 311. Then, by using a set of the plurality of dots 311 in a unit region, the position information pattern is formed.

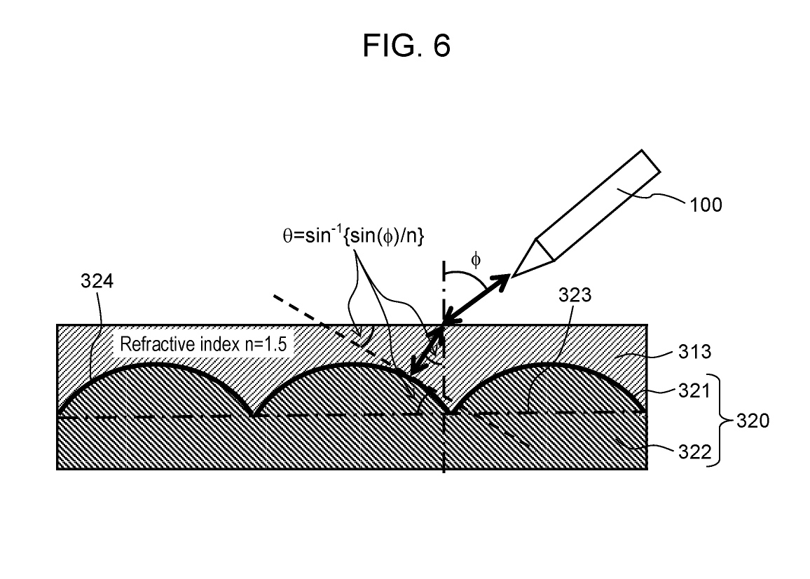

As shown in FIG. 6, infrared reflective sheet 320 is structured by knobby base material 322 having corrugated surface 324 on a reference surface, and infrared reflective layer 321 formed along corrugated surface 324 of the knobby base material 322. In order to enhance the infrared reflection performance, knobby base material 322 has corrugated surface 324 having fine knobby shapes to which inclinations of prescribed angles relative to reference surface 323 are defined. Specifically, in connection with knobby base material 322 and infrared reflective sheet 320, when an absolute angle (<90 deg) at which a tangent of each knobby shape of corrugated surface 324 is inclined with respect to reference surface 323 is an absolute inclination angle θ, a distribution rate f (θ=25 deg) of corrugated surface 324 having the absolute inclination angle θ of 25 deg is 1.0[%/deg] or more, and a proportion of a projected area of a region where the absolute inclination angle θ of corrugated surface 324 is 40 deg or more to a total effective area of infrared reflective sheet 320 is 20% or less. Here, the distribution rate f (θ) is represented by the following Equation (1):

f(θ)=(ds/Sa)/dθ Equation (1)

Here, Sa is the total effective area of infrared reflective sheet 320. The total effective area is a total projected area of a region where the knobby shapes of corrugated surface 324 are substantially uniformly formed (an effective surface). dθ is a minute angle near the absolute inclination angle θ. ds is the projected area, in the effective surface, of a region in which the absolute inclination angle of corrugated surface 324 falls within a range of θ to θ+dθ. The projected area is not an area of the curved surface along the knobby shapes of corrugated surface 324, but is an area of a plane in which corrugated surface 324 is projected on an averaged plane (the reference surface).

By forming corrugated surface 324 of knobby base material 322 in this manner, infrared reflective sheet 320 is provided with a better reflection characteristic to infrared light, and color tone can be prevented from shifting from the infrared region to the visible region. Accordingly, reading precision of electronic pen 100 in reading a position information pattern can be secured, and image quality of an image being displayed with visible light can also be secured. The measurement results for explaining this effect will be detailed later in Examples 1 to 3 and Comparative Examples 1 and 2.

Infrared reflective layer 321 transmits visible light while reflecting infrared light. From a microscopic viewpoint, infrared reflective layer 321 specularly reflects infrared light. On the other hand, from a macroscopic viewpoint, since infrared reflective sheet 320 is provided with infrared reflective layer 321 along corrugated surface 324, infrared reflective sheet 320 functions as an infrared diffusing reflective member that diffusively reflects infrared light.

Transparent adhesion layer 313 is a layer for bonding dot pattern sheet 310 and infrared reflective sheet 320 to each other. Transparent adhesion layer 313 has a refractive index that is substantially identical to those of the material of PET film 312 and the material of knobby base material 322. The surface of dot pattern sheet 310 on infrared reflective sheet 320 side is provided with knobby shapes formed by dots 311. The surface of infrared reflective sheet 320 on dot pattern sheet 310 side is also provided with knobby shapes formed by corrugated surface 324. Therefore, in bonding dot pattern sheet 310 and infrared reflective sheet 320 to each other, transparent adhesion layer 313 fills the gap between dot pattern sheet 310 and infrared reflective sheet 320 so as to flatten their respective knobby shapes, to establish optical coupling.

Transparent adhesion layer 330 is a layer for bonding infrared reflective sheet 320 and liquid crystal panel 340 to each other. Similarly to transparent adhesion layer 313, transparent adhesion layer 330 has a refractive index that is substantially identical to those of the material of PET film 312 and the material of knobby base material 322.

Liquid crystal panel 340 is an apparatus that displays an image based on emission of visible light from a not-shown backlight apparatus, by controlling orientations of liquid crystal molecules.

As shown in FIG. 5, since LED 150 and image reading unit 162 provided to electronic pen 100 are disposed close to each other, the incident angle of illumination light 152 illuminating the effective part and the reflection angle of reflected light 163 effectively extracted into image reading unit 162 are substantially identical to each other, and vary in accordance with a attitude angle of electronic pen 100. That is, since the illumination light having various incident angles is reflected toward nearly the direction from which the light has been input, the position information pattern can be optically read even when the pen is used in various attitudes.

Here, with reference to FIG. 6, a description will be given of a condition of optical sheet 300 for reflecting the reflected light toward the direction from which illumination light 152 has been input from electronic pen 100. In FIG. 6, out of the structure of display apparatus 200, transparent adhesion layer 313, infrared reflective layer 321, and knobby base material 322 are shown.

Corrugated surface 324 formed by knobby base material 322 is covered by transparent adhesion layer 313 and is flattened. It is defined that the refractive index of transparent adhesion layer 313 is n (e.g., n=1.5), the incident angle of light (≅ the attitude angle of electronic pen 100) is φ, and the refractive angle in transparent adhesion layer 313 is θ (an angle that agrees with the absolute inclination angle by which a tangent of corrugated surface 324 is inclined with respect to reference surface 323). Here, refractive angle θ in transparent adhesion layer 313 is obtained by the following Equation (2) according to Snell's law:

θ=sin ⁻¹ { sin(φ)/n} Equation (2)

When the attitude angle φ of electronic pen 100 has changed, in the case where corrugated surface 324 of an inclination angle corresponding to the refractive angle θ calculated by Equation (2) exists on knobby base material 322, reflected light that is return-reflected toward the direction from which illumination light 152 has been input from electronic pen 100 is generated.

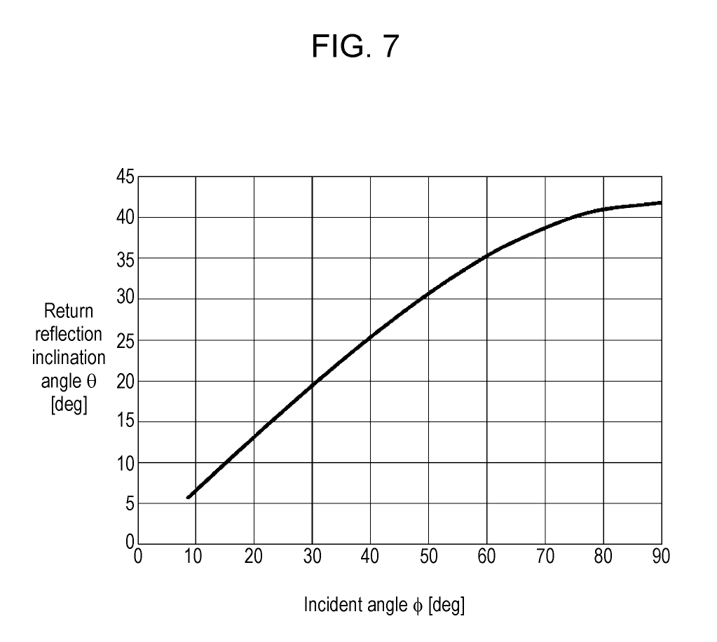

FIG. 7 shows, as to the case where the refractive index n of transparent adhesion layer 313 is 1.5, calculation results of the relationship between incident angle of light (the attitude angle of electronic pen 100) φ and inclination angle θ, that is necessary for causing return reflection for that incident angle θ.

For example, when the attitude angle of electronic pen 100 is 40 deg, in order to enable reading of a position information pattern, corrugated surface 324 having an inclination angle of about 25 deg on knobby base material 322 is required. Then, as a probability of existence of corrugated surface 324 having the inclination angle of about 25 deg on knobby base material 322 is higher, it is expected that electronic pen 100 can obtain bright infrared reflected light.

Further, provided that the maximum angle of the attitude angle of electronic pen 100 is about 75 deg that is a slightly inclined angle from a perpendicular angle (90 deg), as shown in FIG. 7, it can be seen that the angle of the inclined surface of corrugated surface 324 on knobby base material 322 is preferably distributed in a range from 0 deg to 40 deg. As shown in FIG. 7, corrugated surface 324 having an inclination angle greater than 40 deg meaninglessly brings about total reflection on the flattened surface upon output, and rather reduces reflection efficiency.

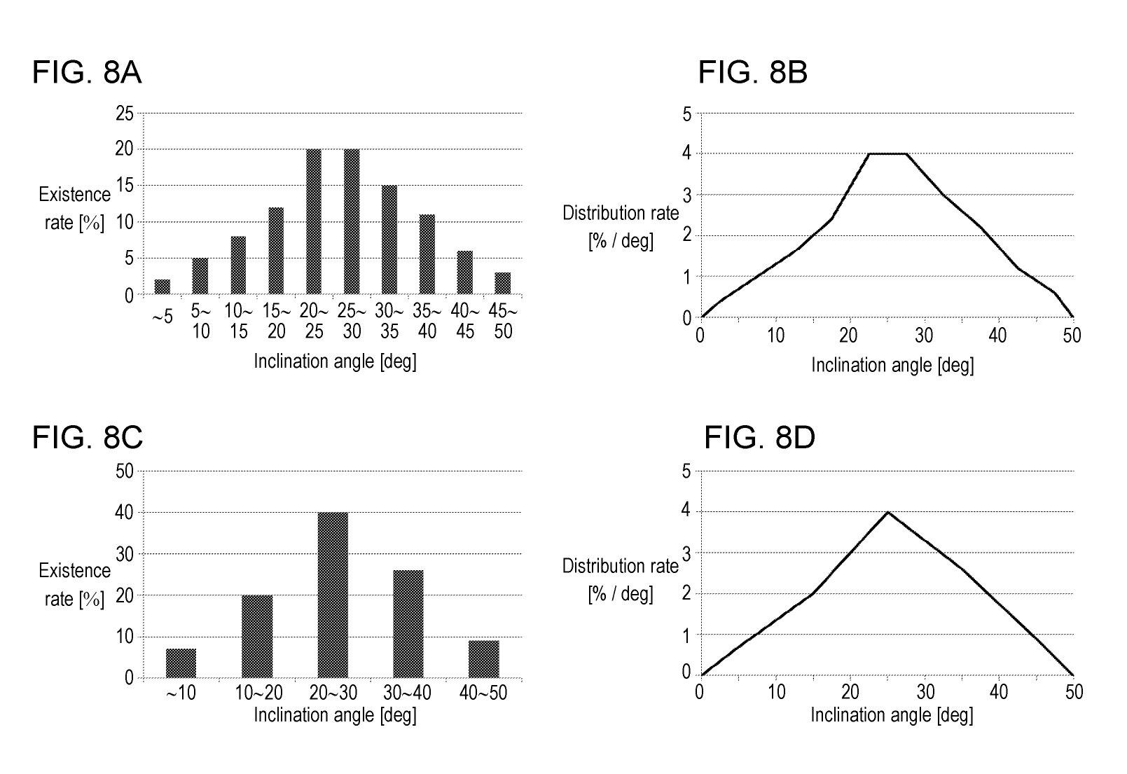

FIGS. 8A to 8D are diagrams showing existence rates and the distribution rates of surfaces around a particular inclination angle on corrugated surface 324 of knobby base material 322. A known method for quantifying inclination angle distribution of corrugated surface 324 includes a means for representing measurement data obtained by a three-dimensional measuring device, a laser microscope and the like as a histogram.

FIGS. 8A and 8C are histograms both created from an identical virtual population. Here, each of horizontal axes represents a range of the inclination angle (absolute inclination angle θ) of corrugated surface 324, and each of vertical axes represents an existence ratio of the surfaces, on knobby base material 322, around the inclination angle represented by the horizontal axis thereof. Note that, FIG. 8A shows the inclination angle in breakup by 5 deg, whereas FIG. 8C shows the inclination angle in breakup by 10 deg. While a profile of FIG. 8A and that of FIG. 8C are similar to each other because they are created from the identical population, one of the vertical axes of FIGS. 8A and 8C nearly doubles the other.

On the other hand, FIGS. 8B and 8D are graphs of the distribution rate respectively created from FIGS. 8A and 8C. In FIGS. 8B and 8D, each of horizontal axes represents a median value of each region in breakup with reference to the inclination angle represented by each of horizontal axes of FIGS. 8A and 8C, and each of vertical axes represents the distribution rate [%/deg] which is obtained by dividing the existence rate [%] of surfaces, on knobby base material 322, falling within a range of the inclination angle shown by each breakup region by the range of the inclination angle [deg]. By representing in this manner, quantification being independent of the manner of breaking up the angle range can be realized.

While details will be omitted, it is also possible that, in the case where corrugated surface 324 is made of a transparent material similarly to knobby base material 322, a parallel light beam may be input to corrugated surface 324 to measure luminosity distribution of the transmitted light. Then, by solving simultaneous differential equations of a differential equation being a defining equation of luminosity and a differential equation being a defining equation of the inclination angle distribution, the inclination angle distribution of corrugated surface 324 may be derived.

In the following, with reference to the drawings, a description will be given of Examples and Comparative Examples according to the present disclosure.

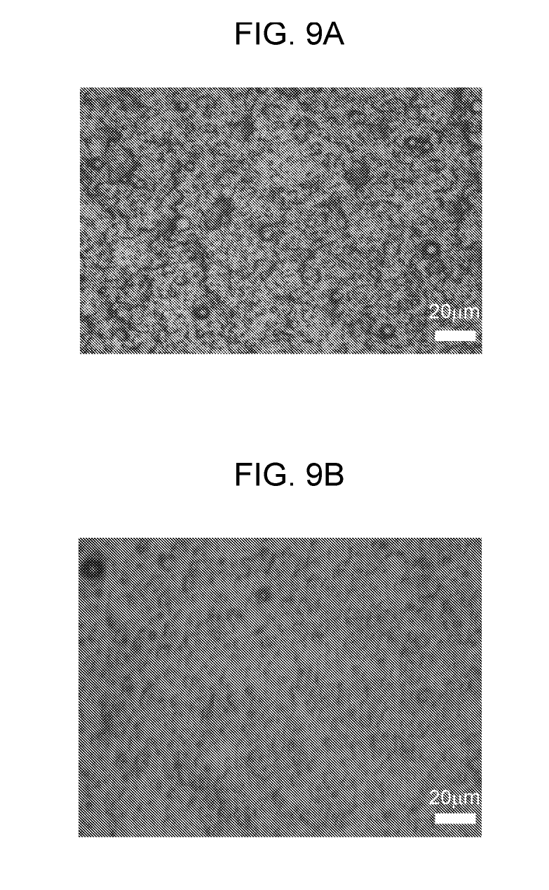

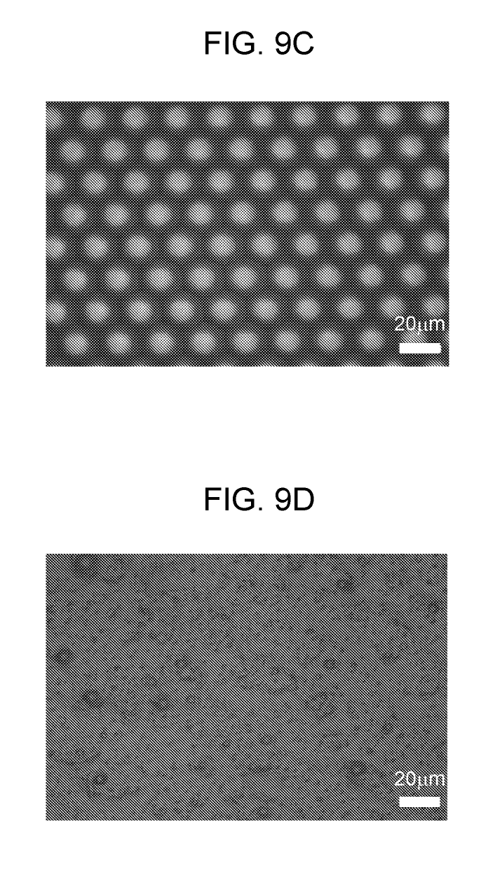

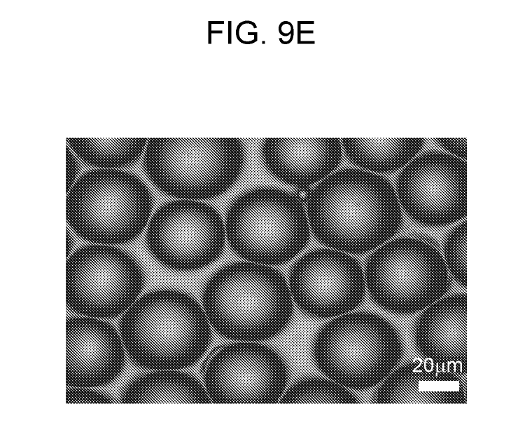

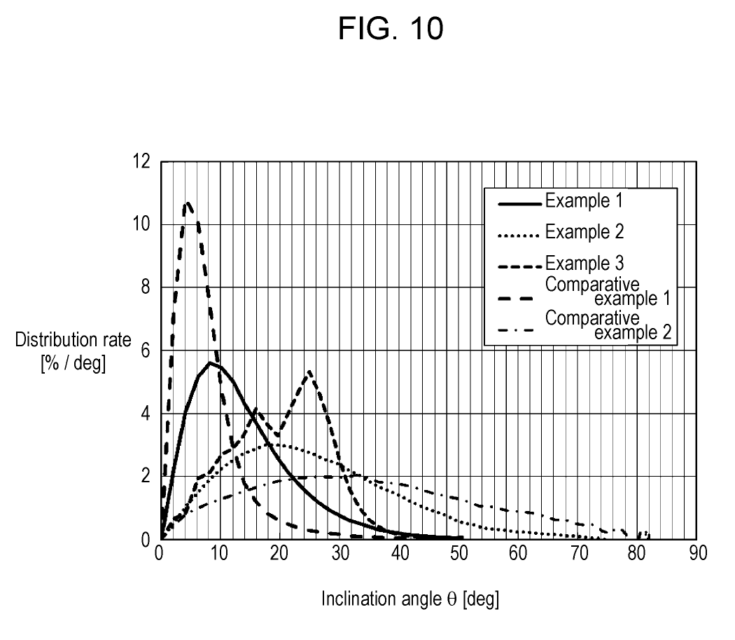

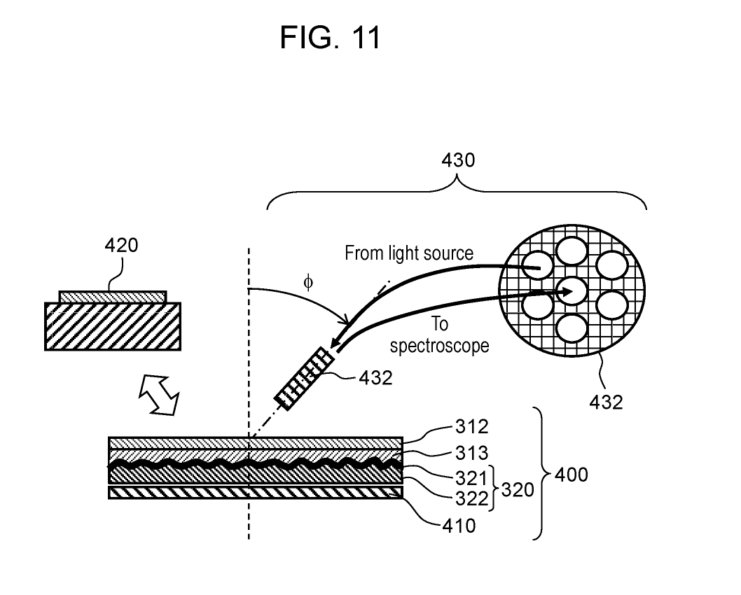

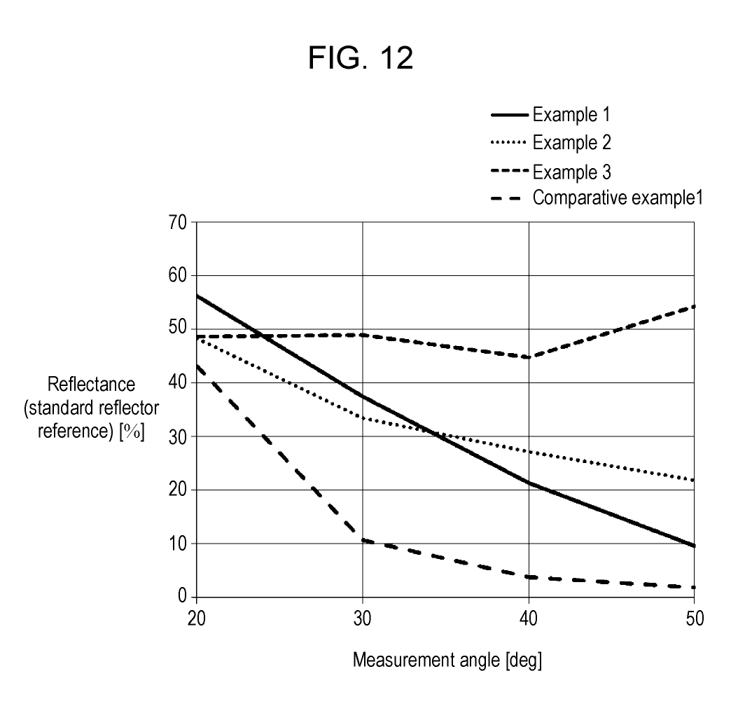

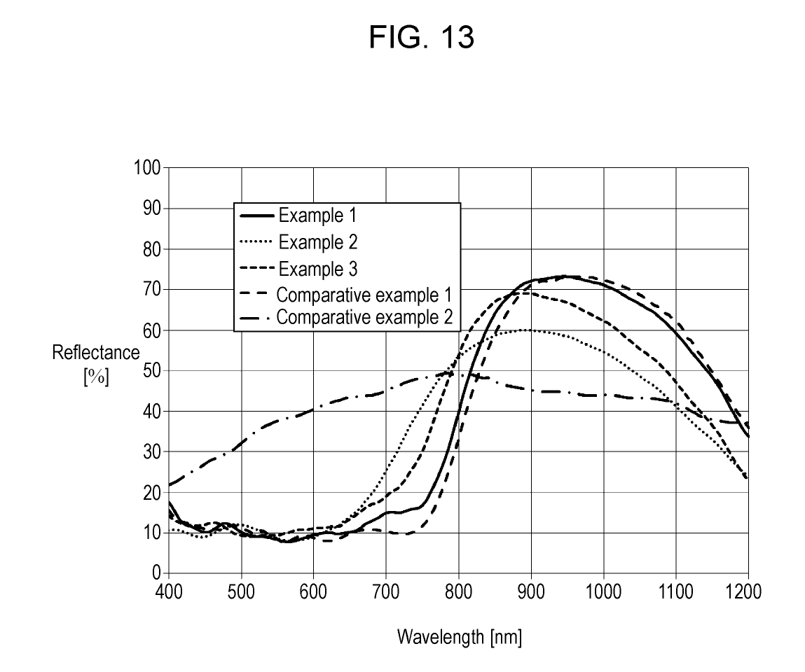

FIGS. 9A to 9E are surface photographs in Examples and Comparative Examples. FIG. 10 is a diagram showing the distribution rate (the distribution rate obtained by the quantification explained with reference to FIGS. 8A to 8D) for the inclination angle θ in Examples and Comparative Examples. FIG. 11 is a diagram showing a structure of test sheet 400 and a structure of diffuse reflection measuring apparatus 430. FIG. 12 is a diagram showing diffuse reflectance at various measurement angles with wavelength of 950 nm in Examples and Comparative Examples. FIG. 13 is a diagram showing spectral reflectance in Examples and Comparative Examples. Further, Table 1 shows the characteristics of the inclined surface distribution of knobby base material 322, and summaries of the evaluation results about the image quality (brightness, contrast) of display apparatus 200 and the reading performance of the position information pattern by electronic pen 100, in Examples 1 to 3 and Comparative Examples 1 and 2.

TABLE 1

| | | | | | Comparative | Comparative |
|---|---|---|---|---|---|---|
| | | Example 1 | Example 2 | Example 3 | example 1 | example 2 |
| Knobby | 25 deg distribution | 1.4 | 2.7 | 5.3 | 0.3 | 1.9 |
| substrate | rate (%/deg) | | | | | |
| inclination | Occupancy of | 1.0 | 16.4 | 0.7 | 0.3 | 35.0 |
| angle | 40 deg or more (%) | | | | | |
| distribution | | | | | | |
| Display | Pen performance | ◯ | ◯ | ⊚ | X | ◯ |
| apparatus | (40 deg inclination | | | | | |
| performance | pen speed) | | | | | |
| evaluation | Image quality | ⊚ | ◯ | ◯ | ⊚ | X |

| | | | | | |
|---|---|---|---|---|---|
| Total evaluation | ◯ | ◯ | ◯ | X | X |

A description will be given of each of the measurement results in Examples 1 to 3 and Comparative Examples 1 and 2. In the following descriptions, the reference characters a to e are respectively allotted to ends of the constituent elements in Examples 1 to 3 and Comparative Examples 1 and 2 for identification. However, when common constituent elements are used in Examples 1 to 3 and Comparative Examples 1 and 2, such reference characters are not allotted to those elements.

### EXAMPLE 1

Electronic pen 100 was prepared using an infrared LED having a peak wavelength of 950 nm as LED 150.

As shown in FIG. 11, test sheet 400a according to Example 1 was formed. In order to reject influence of infrared light-absorbing dots 311 provided to dot pattern sheet 310 and to purely evaluate a characteristic of infrared reflective sheet 320a, test sheet 400a was prepared by bonding infrared reflective sheet 320a (infrared reflective layer 321 and knobby base material 322a) and PET film 312 not provided with dots 311 to each other using transparent adhesion layer 313. Further, black-color sheet 410 was used in place of liquid crystal panel 340.

Knobby base material 322a according to Example 1 had the surface shape as shown in the surface photograph of FIG. 9A, and had the absolute inclination angle distribution (distribution rate f(θ) for inclination angle θ) of the knobby shapes, which is represented by a solid line (Example 1) in the graph of FIG. 10. More specifically, as shown in Table 1, with reference to knobby base material 322a, the distribution rate f (25 deg) of corrugated surface 324a, having an absolute inclination angle of 25 deg was 1.4[%/deg]. Further, with reference to knobby base material 322a, the proportion of the projected area of a region where the absolute inclination angle of corrugated surface 324a was 40 deg or more to a total effective area of infrared reflective sheet 320a was 1.0%.

On corrugated surface 324a of knobby base material 322a, several optical materials differing from each other in refractive index were alternately stacked by sputtering, to form infrared reflective layer 321. Thus, infrared reflective sheet 320a was obtained.

Subsequently, a description will be given of measurement of the diffusion reflection characteristic of test sheet 400a prepared as described above. The diffusion reflection characteristic is measured by using diffuse reflection measuring apparatus 430 as shown in FIG. 11. Light is emitted by a specific angle, and only a part of the emitted light returned in the direction from which the light has been input is captured and measured. Diffuse reflection measuring apparatus 430 includes a light source and a spectroscope which are not shown, and probe 432. The light source emits light ranging from the visible region to the infrared region. The light emitted from the light source is input to test sheet 400a via probe 432. Probe 432 is provided with seven optical fibers. The one at the center is connected to the spectroscope, and the surrounding six optical fibers are connected to the light source. Probe 432 emits the light to test sheet 400a, as being inclined by a measurement angle φ (corresponding to an absolute inclination angle φ) of electronic pen 100) with reference to a normal direction of a surface of test sheet 400a. Test sheet 400a reflects a part of the light from probe 432 in a direction of probe 432. This reflected light is guided to the spectroscope via probe 432. In this manner, the spectroscope carries out spectrometry.

Note that, as a reference of the spectrometry, standard reflector 420 in which a perfect diffuse surface is stacked on a surface of the reflector as shown in FIG. 11 is used. Then, by calculating a ratio between the measurement result with diffuse reflection measuring apparatus 430 and the measurement result with standard reflector 420, the diffuse reflectance of test sheet 400a is derived.

The diffuse reflectance for each measurement angle with wavelength 950 nm is represented by a solid line (Example 1) in the graph of FIG. 12. The evaluation with wavelength 950 nm being an emission peak wavelength of LED 150 of electronic pen 100 can be used as an index of the reading performance of electronic pen 100. As shown in FIG. 12, it can be seen that test sheet 400a maintains a diffuse reflectance of about 10% to the light emission of 950 nm even when electronic pen 100 is inclined by a measurement angle of 50 deg.

Subsequently, using a general spectrophotometer, the spectral reflectance of test sheet 400a was measured. Light was input at a measurement angle of 8 deg from PET film 312 side of test sheet 400a, and the reflected light was captured by an integrating sphere, to obtain spectrum. Then, under the condition identical to that of test sheet 400a, from a ratio to a standard spectrum obtained by measurement of standard reflector 420 being the reference, the diffuse reflectance was derived.

The measurement result of spectral reflectance according to Example 1 is represented by a solid line (Example 1) in the graph of FIG. 13. As represented by the solid line in the graph of FIG. 13, high reflectivity of 70% or more is shown around the peak wavelength of 950 nm of LED 150. As to the visible light region of wavelengths 430 nm to 700 nm, low reflectivity of about 10% is shown, which agrees with Fresnel reflection at the air interface.

Subsequently, optical sheet 300a was prepared by stacking dot pattern sheet 310 on infrared reflective sheet 320a used as test sheet 400a in Example 1. Dot pattern sheet 310 had dots 311 being an infrared absorbing layer in which transmittance with 950 nm was 5% (absorptance 95%) and effective transmittance of visible light was 80%. Further, by bonding the surface of dot pattern sheet 310 where the knobby shapes of dots 311 were formed and the surface of infrared reflective sheet 320a where infrared reflective layer 321a was stacked on the knobby shapes of knobby base material 322a to each other by acrylic transparent adhesion layer 313, optical sheet 300a was formed. Further, by bonding optical sheet 300a and liquid crystal panel 340 to each other, display apparatus 200a was prepared.

With reference to display apparatus 200a, a test of reading a position information pattern by using electronic pen 100 was conducted. When the attitude of electronic pen 100 was substantially perpendicular (0 deg) with reference to display unit 240 of display apparatus 200a, a clear image could be obtained even with a short exposure time, and an extremely fast pen speed could be followed. As a result, small power consumption could be achieved.

As the inclination angle of electronic pen 100 from the perpendicular direction with reference to display unit 240 of display apparatus 200a becomes greater, the diffuse reflectance reduces. Therefore, while the increased exposure time of image reading unit 162 was necessary, an excellent image could be acquired up to an inclination angle of 50 deg, and the performance of detecting the position information pattern was excellent.

Further, when an image was displayed on liquid crystal panel 340 with visible light, excellent display quality was achieved substantially without a reduction in brightness of the image light as compared to the state where no optical sheet 300a is stacked, or without a reduction in contrast invited by an increase in external light reflection.

### EXAMPLE 2

Similarly to Example 1, test sheet 400b, optical sheet 300b, and display apparatus 200b according to Example 2 were prepared, and various characteristics were measured.

A difference from Example 1 will be described. As knobby base material 322b according to Example 2, what was used was a diffusion sheet having the surface shape shown in the surface photograph of FIG. 9B, and having the absolute inclination angle distribution (distribution rate f(θ) for inclination angle θ) of the knobby shapes, represented by a dotted line (Example 2) in the graph of FIG. 10. More specifically, as shown in Table 1, with reference to knobby base material 322b, the distribution rate f (25 deg) of corrugated surface 324b, having an absolute inclination angle θ of 25 deg was 2.7[%/deg]. Further, with reference to knobby base material 322b, the proportion of the projected area of a region where the absolute inclination angle of corrugated surface 324b was 40 deg or more to a total effective area of infrared reflective sheet 320b was 16.4%.

As represented by a dotted line (Example 2) in the graph of FIG. 12, test sheet 400b maintains a diffuse reflectance of about 20% even when electronic pen 100 is inclined by a measurement angle of 50 deg.

The measurement result of reflectivity to the emission wavelength in Example 2 is represented by a dotted line (Example 2) in the graph of FIG. 13. As represented by the dotted line in the graph of FIG. 13, while the reflection peak wavelength is slightly shifted toward a short wavelength side as compared to Example 1 represented by the solid line and the reflectivity around 950 nm is slightly reduced, the reflectivity value of about 60% is shown. Further, in the visible region, while a slight increase in reflectivity is shown in a long wavelength region, an increase from an amount of Fresnel reflection is minor.

With reference to display apparatus 200b, a test of reading a position information pattern by using electronic pen 100 was conducted. When the attitude of electronic pen 100 was in a range from perpendicular (0 deg) to 50 deg with reference to display unit 240 of display apparatus 200b, the position information pattern could be detected in an excellent manner.

Further, when an image was displayed on liquid crystal panel 340 with visible light, a reduction in brightness of the image light as compared to the state where no optical sheet 300b is stacked was little observed.

However, the reflection was slightly red-colored in a luminous environment, and a slight reduction in contrast was observed in a dark environment attributed to an increase in external light reflection.

### EXAMPLE 3

Similarly to Example 1, test sheet 400c, optical sheet 300c, and display apparatus 200c according to Example 3 were prepared, and various characteristics were measured.

A difference from Example 1 will be described. As knobby base material 322c according to Example 3, what was used was a lens array sheet having the surface shape shown in the surface photograph of FIG. 9C, and having the absolute inclination angle distribution (distribution rate f(θ) for inclination angle θ) of the knobby shapes, represented by a short-interval broken line (Example 3) in the graph of FIG. 10. More specifically, as shown in Table 1, with reference to knobby base material 322c, the distribution rate f (25 deg) of corrugated surface 324c, having an absolute inclination angle θ of 25 deg was 5.3[%/deg]. Further, with reference to knobby base material 322c, the proportion of the projected area of a region where the absolute inclination angle of corrugated surface 324c was 40 deg or more to a total effective area of infrared reflective sheet 320c was 0.7%.

As represented by a short-interval broken line (Example 3) in the graph of FIG. 12, test sheet 400c maintains a diffuse reflectance of about 50% at any measurement angle in a wide range from 20 deg to 50 deg.

The measurement result of reflectivity to the emission wavelength in Example 3 is represented by a short-interval broken line (Example 3) in the graph of FIG. 13. As represented by the short-interval broken line in the graph of FIG. 13, while the reflection peak wavelength is slightly shifted toward a short wavelength side as compared to Example 1 represented by the solid line and the reflectivity around 950 nm is slightly reduced, the reflectivity value of about 70% is shown. Further, in the visible region, while a slight increase in reflectivity is shown in a long wavelength region, an increase from an amount of Fresnel reflection is minor.

With reference to display apparatus 200c, a test of reading a position information pattern by using electronic pen 100 was conducted. When the attitude of electronic pen 100 was in a range from perpendicular (0 deg) to 50 deg with reference to display unit 240 of display apparatus 200c, the position information pattern could be detected in an excellent manner.

Further, when an image was displayed on liquid crystal panel 340 with visible light, a reduction in brightness of the image light as compared to the state where no optical sheet 300c is stacked was little observed.

However, the reflection was slightly red-colored in a luminous environment, and a slight reduction in contrast was observed in a dark environment attributed to an increase in external light reflection.

### COMPARATIVE EXAMPLE 1

Similarly to Examples 1 to 3, test sheet 400d, optical sheet 300d, and display apparatus 200d according to Comparative Example 1 were prepared.

A difference from Examples 1 to 3 will be described. Knobby base material 322d according to Comparative Example 1 has the surface shape shown in the surface photograph of FIG. 9D, and has the absolute inclination angle distribution (distribution rate f(θ) to inclination angle θ) represented by a long-interval broken line (Comparative Example 1) in the graph of FIG. 10. More specifically, as shown in Table 1, with reference to knobby base material 322d, the distribution rate f (25 deg) of corrugated surface 324d, having an absolute inclination angle θ of 25 deg was 0.3[%/deg]. Further, with reference to knobby base material 322d, the proportion of the projected area of a region where the absolute inclination angle of the corrugated surface 324d was 40 deg or more to a total effective area of infrared reflective sheet 320d was 0.3%.

As represented by a long-interval broken line (Comparative Example 1) in the graph of FIG. 10, the inclined surface distribution of corrugated surface 324d of knobby base material 322c has the peak around 5 deg, and as compared to Example 1, the components of 10 deg or more are fewer.

As represented by a long-interval broken line (Comparative Example 1) in the graph of FIG. 12, a diffuse reflectance of test sheet 400d sharply reduces as the measurement angle increases, and is 10% at 30 deg and 5% or less at 40 deg or more.

Further, the measurement result of reflectivity to the emission wavelength in Comparative Example 1 is represented by a long-interval broken line (Comparative Example 1) in the graph of FIG. 13. As represented by the long-interval broken line in the graph of FIG. 13, high reflectivity of 70% or more is shown around the peak wavelength of 950 nm of LED 150. As to the visible light region of 430 nm to 700 nm, low reflectivity of about 10% is shown, which agrees with Fresnel reflection at the air interface.

With reference to display apparatus 200d, a test of reading a position information pattern by using electronic pen 100 was conducted. When the attitude of electronic pen 100 was substantially perpendicular (0 deg) with reference to a display surface of display apparatus 200d, the position information pattern could be detected in an extremely excellent manner. However, when the pen attitude was over 30 deg, the brightness and contrast of an infrared image that could be acquired gradually reduced. When the attitude of electronic pen 100 was inclined at 40 deg or more, the coordinates could not be detected.

This may be attributed to, in corrugated surface 324d of infrared reflective sheet 320d, an insufficient component rate (distribution rate) around the inclination angle of 25 deg, which is necessary for causing return reflection in the case where the attitude of electronic pen 100 is 40 deg.

Note that, when an image was displayed on liquid crystal panel 340 with visible light, a reduction in brightness and a reduction in contrast of the image light as compared to the state where no optical sheet 300d is stacked were little observed, and excellent display quality was achieved.

### COMPARATIVE EXAMPLE 2

Similarly to Examples 1 to 3 and Comparative Example 1, test sheet 400e, optical sheet 300e, and display apparatus 200e according to Comparative Example 2 were prepared, and various characteristics were measured.

A difference from Examples 1 to 3 and Comparative Example 1 will be described. As knobby base material 322e according to Comparative Example 2, what was used was a lens array sheet having the surface shape shown in surface photograph of FIG. 9E, and having the absolute inclination angle distribution (distribution rate f(θ) to inclination angle θ) of the knobby shapes, represented by a dot-dash line (Comparative Example 2) in the graph of FIG. 10. More specifically, as show in Table 1, with reference to knobby base material 322e, the distribution rate f (25 deg) of corrugated surface 324e, having an absolute inclination angle θ of 25 deg was 1.9[%/deg]. Further, with reference to knobby base material 322e, the proportion of the projected area of a region where the absolute inclination angle of corrugated surface 324e was 40 deg or more to a total effective area of infrared reflective sheet 320e was 35.0%. Note that, as represented by a dot-dash line (Comparative Example 2) in the graph of FIG. 10, the inclined surface distribution of corrugated surface 324e of knobby base material 322e substantially agrees with a calculation result of a hemisphere.

The measurement result of reflectivity to the emission wavelength in Comparative Example 2 is represented by a dot-dash line (Comparative Example 2) in the graph of FIG. 13. As represented by the dot-dash line in the graph of FIG. 13, wavelength selectivity is little shown. Further, as compared to Examples 1 to 3 and Comparative Example 1, great reflectivity is shown in the visible region. This may be explained as follows. In corrugated surface 324e of infrared reflective sheet 320e, inclination components of 40 deg or more not contributing to the return reflection into electronic pen 100 are greatly contained. As a result, it is considered that shift of the selective wavelength characteristic by inclined light input, total reflection at the surface where the reflected light is output, and the like may take place. When infrared reflective sheet 320e having such optical characteristics is provided at the display surface of display apparatus 200, brightness of an image with visible light is largely impaired. Further, a reduction in contrast under external light is significant, largely impairing the display quality of the image. Accordingly, as to Comparative Example 2, further evaluations such as a test of reading a position information pattern by using electronic pen 100 were not performed.

As described above, referring to Table 1, in connection with Comparative Example 1 in which the distribution of inclined surfaces of knobby base material 322 is centered to 10 deg or less and the distribution rate of 25 deg is as small as 0.3[%/deg], the image quality of display apparatus 200 can be secured with a level that is a certain reference or more. However, the angle of pen attitude with which electronic pen 100 can precisely read a position information pattern is limited. In particular, a position information pattern cannot be read sufficiently at 40 deg, which is the pen attitude angle particularly frequently used.

On the other hand, in connection with Comparative Example 2 in which the components where the angle of inclined surface of knobby base material 322 is 40 deg or more are as great as 35%, the inclined surface being substantially hemispheric, it is difficult to realize the intended wavelength selectivity characteristic, and to secure the image quality of display apparatus 200 with a level that is a certain reference or more.

From the foregoing, infrared reflective sheet 320 (knobby base material 322) should be structured as follows. When an absolute angle (<90 deg) at which a tangent of each knobby shape of corrugated surface 324 is inclined with respect to reference surface 323 is an absolute inclination angle θ, the distribution rate f (θ=25 deg) with absolute inclination angle θ of 25 deg, of corrugated surface 324 is 1.0[%/deg] or more, and the proportion of a projected area, on reference surface 323, of a region where absolute inclination angle θ of corrugated surface 324 is 40 deg or more to a total effective area of infrared reflective layer 321 is 20% or less. By forming corrugated surface 324 of knobby base material 322 in this manner, a better reflection characteristic to infrared light can be attained, and color tone can be prevented from shifting from the infrared region to the visible region. Accordingly, the reading precision of electronic pen 100 in reading a position information pattern can be secured, and the image quality of an image being displayed with visible light can also be secured.

### Other Exemplary Embodiment

In the foregoing, for the purpose of exemplifying the technique of the present disclosure, the exemplary embodiment has been described. However, the technique of the present disclosure is not limited thereto, and is applicable to the exemplary embodiment having been subjected to modification, replacement, addition, omission, and the like as appropriate. Further, it is also possible to form a new exemplary embodiment by combining the constituent elements described in the exemplary embodiment. Accordingly, in the following, another exemplary embodiment will be described.

In Examples described above, infrared emission is employed for LED 150 of electronic pen 100 in order that the absorption wavelength of dots 311 of dot pattern sheet 310 is set to infrared light, and then infrared reflective sheet 320 is used. However, the present disclosure is not limited thereto. For example, it is also possible that ultraviolet emission is employed for LED 150 in order that the absorption wavelength of dot pattern sheet 310 is set to ultraviolet light, and then a knobby reflective sheet reflecting ultraviolet light is used. That is, the system in which electronic pen optically reads, using non-visible light, a position information pattern formed on display unit 240 may be used.

Note that, in the present exemplary embodiment, while the refractive index n of transparent adhesion layer 313, PET film 312, and knobby base material 322 structuring optical sheet 300 is 1.5, a similar result was obtained from experiments with refractive index n of 1.45 to 1.65.

In the foregoing, for the purpose of exemplifying the technique of the present disclosure, the exemplary embodiments are described. For that purpose, the accompanying drawings and the detailed description are provided.

Accordingly, for the purpose of exemplifying the technique, the constituent elements shown in the accompanying drawings and the detailed description may contain not only the constituent elements essential for solving the problem, but also those not essential. Hence, it should not be immediately recognized that those non-essential constituent elements are essential just because those non-essential constituent elements are shown in the accompanying drawings and the detailed description.

Further, since the above exemplary embodiments are intended to exemplify the technique of the present disclosure, various modifications, substitutions, additions, and omissions can be made within the scope of claims or within a scope equivalent thereto.

As described above, the present disclosure is a useful invention in smoothly carrying out input operations by using an input pen to a display apparatus.

What is claimed is:

1. A non-visible light reflective sheet comprising:
a base material having a corrugated surface on a reference surface; and
a reflective layer formed along the corrugated surface and reflecting non-visible light, wherein,
when an angle of a tangent of the corrugated surface being inclined with respect to the reference surface is an inclination angle, a distribution rate of the inclination angle of 25 deg is 1.0[%/deg] or more, and a proportion of a projected area, onto the reference surface, of a region where the inclination angle is 40 deg or more to a total area of the reference surface is 20% or less.

2. The non-visible light reflective sheet according to claim 1, wherein the distribution rate is obtained from an equation
f(θ)=(ds/Sa)/dθ
where f(θ) is the distribution rate, θ is the inclination angle (deg) of the tangent of the corrugated surface, dθ is a minute angle (deg) around θ, ds is the projected area, onto the reference surface, of the corrugated surface in a region where the inclination angle falls within a range from θ to θ+dθ , and Sa is a total effective area of the reflective layer.

3. An optical sheet comprising:
a non-visible light reflective sheet; and
a pattern sheet stacked on the non-visible light reflective sheet and provided with a pattern that absorbs or reflects non-visible light for showing positional information, wherein
the non-visible light reflective sheet includes
a base material having a corrugated surface on a reference surface, and
a reflective layer formed along the corrugated surface and reflecting non-visible light, wherein,
when an angle of a tangent of the corrugated surface being inclined with respect to the reference surface is an inclination angle, a distribution rate of the inclination angle of 25 deg is 1.0[%/deg] or more, and a proportion of a projected area, onto the reference surface, of a region where the inclination angle is 40 deg or more to a total area of the reference surface is 20% or less.

4. The optical sheet according to claim 3, wherein
a refractive index is from 1.45 to 1.65.

5. A display apparatus comprising:
a display panel having a display region that displays an image; and
an optical sheet disposed on the display region, wherein
the optical sheet includes
a non-visible light reflective sheet, and
a pattern sheet stacked on the non-visible light reflective sheet and provided with a pattern that absorbs or reflects non-visible light for showing positional information, wherein
the non-visible light reflective sheet includes
a base material having a corrugated surface on a reference surface, and a reflective layer formed along the corrugated surface and reflecting non-visible light, wherein,
when an angle of a tangent of the corrugated surface being inclined with respect to the reference surface is an inclination angle, a distribution rate of the inclination angle of 25 deg is 1.0[%/deg] or more, and a proportion of a projected area, onto the reference surface, of a region where the inclination angle is 40 deg or more to a total area of the reference surface is 20% or less.
